(19) United States
(12) Patent Application Publication
(10) Pub. No.: US 2025/0265470 A1
(43) Pub. Date: Aug. 21, 2025

(54) METHOD AND SYSTEM FOR LEARNING TABULAR DATA ANALYZING MODEL

(71) Applicant: LG MANAGEMENT DEVELOPMENT INSTITUTE CO., LTD., Seoul (KR)

(72) Inventors: Kyungeun Lee, Seoul (KR); Yeseul Sim, Seoul (KR); Hyeseung Cho, Seoul (KR); Moonjung Eo, Seoul (KR); Suhee Yoon, Seoul (KR); Sanghyu Yoon, Seoul (KR); Woohyung Lim, Seoul (KR)

(21) Appl. No.: 18/929,545

(22) Filed: Oct. 28, 2024

(30) Foreign Application Priority Data
Feb. 15, 2024 (KR) 10-2024-0022082
Oct. 23, 2024 (KR) 10-2024-0145969

(51) Int. Cl. G06N 3/09; G06N 3/0455

(52) U.S. Cl. CPC G06N 3/09; G06N 3/0455

(57) ABSTRACT

A method for learning tabular data analyzing model in a computing system including a memory and a processor, the method includes the steps of: acquiring tabular data; performing binning on the tabular data to acquire binned data; and training an autoencoder to output the binned data from the input tabular data.

### CROSS-REFERENCE TO RELATED APPLICATIONS

This application claims priority from and the benefit of Koran Patent Application No. 10-2024-0145969, filed on Oct. 23, 2024, which claims priority from Korean Provisional Patent Application No. 10-2024-0022082, filed on Feb. 15, 2024, each of which is incorporated herein by reference for all purposes as if fully set forth herein.

### BACKGROUND

### Field

Embodiments of the invention relate generally to a data analysis model training method and system thereof, and more specifically, to method and system for learning tabular data analyzing model.

### Discussion of the Background

In various industrial fields such as an economic field, a healthcare diagnosis field, an e-commerce field, and a manufacturing field, machine learning methods such as classification, detection, and regression for a tabular data set in which features of various types of sample data that are organized in a table format are utilized to derive desired results.

The tabular data set may be structured, for example, in a table format including row information representing a plurality of pieces of heterogeneous feature information of individual samples and column information representing information on one feature of each of such a plurality of samples. For example, the tabular data set may have a table format composed of a plurality of rows Ro1 to Ro11 representing a plurality of pieces of heterogeneous feature information including age, height, weight, and gender of each of a plurality of samples A to K, and a plurality of columns Cn1 to Cn4 representing information on any one of the plurality of pieces of heterogeneous feature information of the plurality of samples A to K as shown in FIG. 6.

Here, heterogeneous features of the tabular data set may include categorical features that are difficult to represent in numbers and can be represented as, for example, a combination of characters, nouns, and specific words, such as gender and country, and numerical features that can be represented in numbers, such as height, weight, and age.

Conventional methods for analyzing such a tabular data set include, for example, XGBoost (Chen & Guestrin, 2016) and CatBoost (Prokhorenkova et al., 2018) that are tree-based machine learning algorithms.

However, since such models are based on supervised learning and learning should be performed using input data and related labeled data, a data labeling task may incur a lot of time and costs. In addition, an error is highly likely to occur in a task for labeling data in a specific field requiring expertise as an amount of data increases, thereby preventing the performance of the model according to learning from being optimized.

In addition, in order to analyze the tabular data set based on an artificial intelligence model, it is necessary to extract superior representations that reflect inherent properties of the tabular data set, and to this end, it is important to effectively process the heterogeneous features of the tabular data set. Furthermore, in order to improve the efficiency of the learning for the tabular data set, it is necessary to apply a proper inductive bias to the input data set so that an irregular function used for learning can be effectively learned.

The above information disclosed in this Background section is only for understanding of the background of the inventive concepts, and, therefore, it may contain information that does not constitute prior art.

### SUMMARY

Methods and systems for learning tabular data analyzing model according to embodiments of the invention are capable of effectively learning related features of tabular data by utilizing binned data acquired from performing binning on the tabular data.

More specifically, methods and systems for learning tabular data analyzing model according to embodiments of the invention are capable of effectively extracting relevant features of a tabular data set by applying a pretext task based on binning for a tabular data set to an auto-encoding-based self-supervised learning (SSL) model.

Further, methods and systems for learning tabular data analyzing model according to embodiments of the invention are capable of performing various downstream tasks based on relevant features of a tabular data set extracted by an auto-encoding-based self-supervised learning (SSL) model.

Additional features of the inventive concepts will be set forth in the description which follows, and in part will be apparent from the description, or may be learned by practice of the inventive concepts.

According to one or more embodiments of the invention, a method for learning tabular data analyzing model in a computing system including a memory and a processor, the method includes the steps of: acquiring tabular data; performing binning on the tabular data to acquire binned data; and training an autoencoder to output the binned data from the input tabular data.

The tabular data may include a plurality of pieces of column information, at least one of the plurality of pieces of column information may include numerical data for a feature of each of a plurality of samples, and the step of performing binning on the tabular data may include a step of assigning the same bin value to some pieces of numerical data in a predetermined range among a plurality of pieces of numerical data for the plurality of samples.

The tabular data may include a plurality of pieces of column information, at least one of the plurality of pieces of column information may include categorical data for a feature of each of the plurality of samples, and the step of performing binning on the tabular data may include a step of assigning different bin values to a plurality of different pieces of categorical data for the plurality of samples.

The step of training the autoencoder may include the steps of training the autoencoder to output a first bin value for first numerical data having the first bin value assigned thereto and training the autoencoder to output a second bin value different from the first bin value for second numerical data having the second bin value assigned thereto.

The step of training the autoencoder may include the steps of training the autoencoder to output a first bin value for first categorical data having the first bin value assigned thereto and training the autoencoder to output a second bin value different from the first bin value for second categorical data having the second bin value assigned thereto.

The method may further include the steps of: generating an embedding vector X for the tabular data; and performing a predetermined operation on the embedding vector X according to [Formula 1] below to generate a transformed feature vector \tilde{X}, wherein the step of performing binning on the tabular data may include a step of performing the binning on the transformed feature vector \tilde{X}.

$$\tilde{X} = ( 1 - M ) ⊙ X + M ⊙ \overline{X} \qquad [ Formula 1 ]$$

(wherein, M is a masking vector, and X̅ is an element replacement vector)

The step of training the autoencoder may include a step of training the autoencoder by optimizing a loss function L_{BinRecon} according to [Formula 2] below.

$${ℒ}_{BinRecon} := \frac{1}{N} {\sum }_{i = 1}^{N} {‖ {t}_{i} - {f}_{d}^{BinRecon} ( {z}_{i} ) ‖}_{2}^{2} \qquad [ Formula 2 ]$$

(where, tᵢ is an i-th bin value, f_{d}^{BinRecon} is a decoder output value, and zᵢ is an i-th latent variable)

The step of training the autoencoder may include a step of training the autoencoder by optimizing a loss function L_{BinXent} according to [Formula 3] below.

$${ℒ}_{BinXent} := \qquad [ Formula 3 ]$$

$$- \frac{1}{Nd} {\sum }_{i = 1}^{N} {\sum }_{j = 1}^{d} {u}_{i}^{j} log {f}_{d}^{BinXent} ( {z}_{i}^{j} ) + ( 1 - {u}_{i}^{j} ) log ( 1 - {f}_{d}^{BinXent} ( {z}_{i}^{j} ) )$$

(where, uᵢ^{j} is a one-hot vector for tᵢ^{j}, which is an i-th bin value for a j-th feature, f_{d}^{BinRecon} is a decoder output value, and zᵢ^{j} is an i-th latent variable)

The autoencoder may include an encoder configured to generate latent variable data based on the tabular data, and a decoder configured to output the binned data based on the latent variable data.

In the step of performing binning on the tabular data, a size of a first range to which some pieces of numerical data having a first bin value assigned thereto among the plurality of pieces of numerical data belong and a size of a second range to which other pieces of numerical data having a second bin value different from the first bin value assigned thereto belong may be different from each other.

The number of bin values for the plurality of pieces of column information included in the tabular data may be substantially 5 to substantially 100.

According to another embodiments of the invention, system for learning tabular data analyzing model, the system includes: at least one memory; and at least one processor configured to read at least one instruction stored in the memory and train a tabular data analyzing model, wherein the at least one processor is configured to acquire tabular data, perform binning on the tabular data to acquire binned data, and train an autoencoder to output the binned data from the input tabular data.

According to another embodiments of the invention, a computing device includes: at least one encoder; at least one decoder; an autoencoder including the at least one encoder and the at least one decoder; and at least one processor configured to control the encoder and the decoder, wherein the at least one processor is configured to acquire tabular data, perform binning on the tabular data to acquire binned data, and train the autoencoder to output the binned data from the input tabular data.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of a computing system for learning tabular data analyzing model according to an embodiment of the invention.

FIG. 2 is a diagram schematically illustrating ASICs of the processor included in the user computing device of FIG. 1 according to an embodiment of the invention.

FIG. 3 is a block diagram of a computing device for learning tabular data analyzing model according to an embodiment of the invention.

FIG. 4 is a block diagram of a computing device for learning tabular data analyzing model according to another embodiment of the invention.

FIG. 5 is a flowchart illustrating a learning process for tabular data according to an embodiment of the invention.

FIG. 6 is a tabular data set illustrating a structure of tabular data according to an embodiment of the invention.

FIGS. 7 and 8 illustrate a binning process for tabular data according to an embodiment of the invention.

FIG. 9 illustrates a learning process of an autoencoder based on tabular data according to an embodiment of the invention.

FIG. 10 illustrates a correlation between the number of bin values included in binned data generated through binning for tabular data and performance of a model generated as a result of learning according to an embodiment of the invention.

FIGS. 11 and 12 illustrate a preprocessing process for tabular data according to an embodiment of the invention.

FIG. 13 is a diagram illustrating a structure of an artificial intelligence model obtained by combining an encoder trained based on binned data generated by performing binning on tabular data with a downstream task model according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

### System 1000 for Providing Tabular Data Analysis Model Training Service

Hereinafter, an embodiment of system for learning tabular data analyzing model in which binning for assigning bin values to various data values included in the tabular data set according to a predetermined criterion is performed, and the autoencoder is trained by utilizing binned data acquired by performing the binning on the tabular data set in order to efficiently learn the tabular data set will be described in detail with reference to the accompanying drawings.

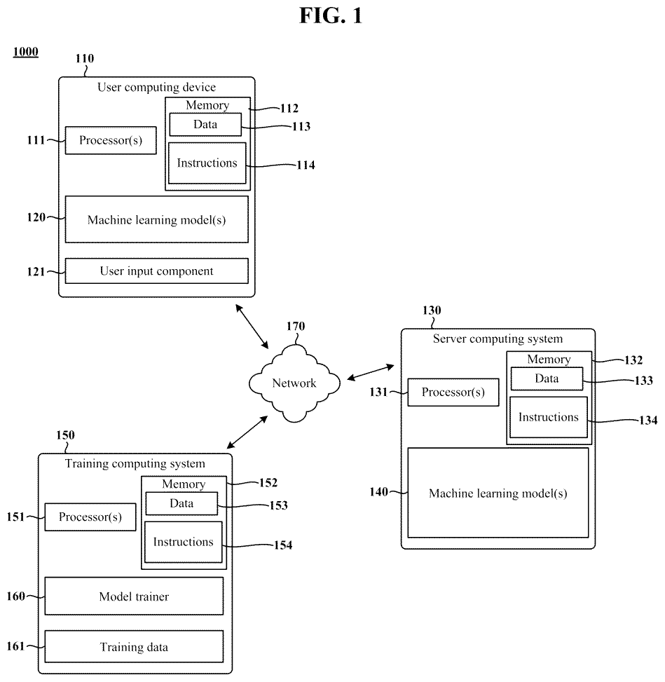

FIG. 1 is a block diagram of a computing system for learning tabular data analyzing model according to an embodiment of the invention.

Referring to FIG. 1, a computing system 1000 for learning tabular data analyzing model according to an embodiment includes a user computing device 110, a server computing system 130, and a training computing system 150, which may be in communication with each other via a network 170.

A method for learning tabular data analyzing model according to an embodiment of the invention may be: 1) implemented and provided locally by the user computing device 110; 2) implemented and provided in the form of a web service by the server computing system 130 communicating with the user computing device 110; or 3) implemented and provided by the user computing device 110 and the server computing system 130 in conjunction with each other.

In this case, in the illustrated embodiment, the user computing device 110 and/or the server computing system 130 can train a machine learning model(s) 120 and/or 140 through interaction with the training computing system 150 communicatively connected via the network 170. The training computing system 150 may be a separate system from the server computing system 130 or may be a part of the server computing system 130.

In this case, an artificial intelligence model may be: 1) trained directly by the user computing device 110 locally; 2) trained by the server computing system 130 and the user computing device 110 interacting with each other through the network 170; and/or 3) trained by a separate training computing system 150 using various training techniques and learning techniques. The artificial intelligence model may be implemented in a manner in which the artificial intelligence model trained by the training computing system 150 is transmitted to the user computing device 110 and/or the server computing system 130 via the network 170 and provided/updated.

In some embodiments, the training computing system 150 may be a part of the server computing system 130 or may be a part of the user computing device 110.

### User Computing Device 110

The user computing device 110 may include any type of computing device, such as a smart phone, a mobile phone, a digital broadcasting device, a personal digital assistant (PDA), a portable multimedia player (PMP), a desktop, a wearable device, an embedded computing device, and/or a tablet PC.

The user computing device 110 may include at least one processor 111 and a memory 112. The processor 111 may be configured of at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions, or a plurality of electrically connected processors.

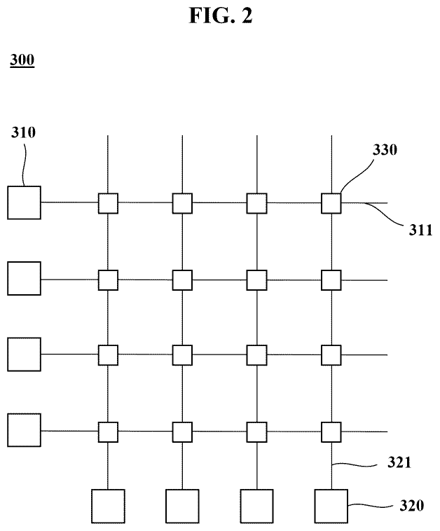

FIG. 2 is a diagram schematically illustrating an ASICs of the processor included in the user computing device 110 of FIG. 1.

ASICs according to an embodiment may have a neuromorphic circuit architecture in the form of an array containing multiple neuron circuits.

Referring to FIG. 2, for example, the neuromorphic circuit 300 may include a plurality of pre-synaptic neuron circuits 310, a plurality of pre-synaptic lines 311 extending laterally from the plurality of pre-synaptic neuron circuits 310, a plurality of post-synaptic neuron circuits 320, a plurality of post-synaptic lines 321 extending longitudinally from the plurality of post-synaptic neuron circuits 320, and a plurality of synaptic circuits 330 provided at intersections between the plurality of pre-synaptic lines 310 and the plurality of post-synaptic lines 321.

The plurality of pre-synaptic neuron circuits 310 may transmit signals, which are input from the outside, to the plurality of synaptic circuits 330 through the plurality of pre-synaptic lines 311 in the form of electrical signals.

In addition, the plurality of post-synaptic neuron circuits 320 may receive electrical signals from the plurality of synaptic circuits 330 through the plurality of post-synaptic lines 321.

In addition, the plurality of post-synaptic neuron circuits 320 may transmit electrical signals to the plurality of synaptic circuits 330 through the plurality of post-synaptic lines 321.

The plurality of synaptic circuits 330 may store weights included in layers constituting a neural network system implemented by a neuromorphic circuit 300, and perform a predetermined operation based on the weights and input data.

For example, each of the plurality of synaptic circuits 330 may include a resistive memory cell having a variable resistance. In this case, the resistance value of the plurality of synaptic circuits 330 can change by the voltage applied through the plurality of pre-synaptic neuron circuits 310 or the plurality of post-synaptic neuron circuits 320, and weight data according to this resistance change can be stored.

The neuromorphic circuit 300 is provided by simulating the structures of neurons and synapses, which are essential elements of the human brain. When a deep neural network (DNN) is realized using the neuromorphic circuit 300, high-speed data processing and/or low power consumption may be more easily realized than the case of using a von Neumann architecture.

Referring back to FIG. 1, the memory 112 may include one or more non-transitory/transitory computer-readable storage media, such as a RAM, a ROM, an EEPROM, an EPROM, a flash memory device, and a magnetic disk, and a combination thereof, and may include a web storage of a server that performs a storage function of a memory on the Internet. The memory 112 may store data 113 and instructions 114 for performing functional operations of at least one processor 111, such as training an artificial intelligence model or executing a vision inspection using the artificial intelligence model.

In an embodiment, the user computing device 110 may store at least one machine learning model 120.

For example, the machine learning models 120 may be various machine learning models such as a plurality of neural networks (for example, deep neural networks) for performing the tabular data analyzing model training method, or other types of machine learning models including nonlinear models and/or linear models, and may be configured as a combination thereof.

For example, linear regression, a decision tree, random forest, gradient boosting, a pre-trained language model, a deep learning model, or/and the like may be stored in the machine learning model. The neural network may include at least one of feed-forward neural networks, recurrent neural networks (for example, long short-term memory recurrent neural networks), convolutional neural networks, or/and other types of neural networks.

In addition, according to various embodiments, the user computing device 110 may store a model to be used in respective processes in order to perform at least some of the processes that are performed for the tabular data analyzing model training method, through a large-scale language model (LLM), and a prompt template that serve as a basis of input to the model.

In an embodiment, the user computing device 110 may receive the at least one machine learning model 120 from the server computing system 130 via the network 170, store the machine learning model 120 in the memory 112, and then execute the stored machine learning model 120 on the processor 111 to perform the tabular data analysis, or the like.

According to another embodiment, the server computing system 130 may include at least one machine learning model 140 to perform an operation through the machine learning model 140, and provide the tabular data analyzing model training service to a user in conjunction with the user computing device 110 in a manner of communicating related data with the user computing device 110.

For example, the user computing device 110 may perform the tabular data analyzing model training service in a manner in which the server computing system 130 provides an output for an input of the user using the machine learning model 140 through a web.

In addition, the artificial intelligence model may be implemented in a manner in which at least some of the machine learning models 120 and/or 140 are executed on the user computing device 110 and the others are executed on the server computing system 130.

In addition, the user computing device 110 may include at least one user input component 121 that detects the input of the user. For example, the user input component 121 may include a touch sensor (for example, a touch screen and/or a touch pad) that detects a touch of an input medium (for example, a finger or a stylus) of the user, an image sensor that detects a motion input of the user, a microphone that detects a user voice input, a button, a mouse, a keyboard, and/or the like. In addition, the user input component 121 may include an interface and an external controller (for example, a mouse and/or a keyboard) when an input to the external controller is received through the interface.

### Server Computing System 130

The server computing system 130 may perform a series of processes for providing the tabular data analyzing model training service.

In particular, in the illustrated embodiment, the server computing system 130 can provide the tabular data analyzing model training service by exchanging data necessary for driving of a tabular data analyzing model training service process in an external device, such as the user computing device 110, with the external device.

More particularly, in the illustrated embodiment, the server computing system 130 can provide an environment in which an application for providing the tabular data analyzing model training service can operate in the user computing device 110.

To this end, the server computing system 130 may include an application program, data, instructions, and/or the like for an operation of the application, and may transmit or receive various types of relevant data to or from the external device.

The server computing system 130 may include at least one processor 131 and a memory 132. The processor 131 may be configured of at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions, or a plurality of electrically connected processors.

For example, ASICs may have a neuromorphic circuit architecture in the form of an array containing multiple neuron circuits as shown in FIG. 2.

The memory 132 may include one or more non-transitory/transitory computer-readable storage media such as a RAM, a ROM, an EEPROM, an EPROM, a flash memory device, and a magnetic disk, and a combination thereof. The memory 132 may store data 133 and instructions 134 for the processor 131 to perform functional operations such as training an artificial intelligence model or executing tabular data analysis through the artificial intelligence model.

In an embodiment, the server computing system 130 may be implemented to include at least one computing device. For example, the server computing system 130 may be implemented so that a plurality of computing devices can operate according to sequential computing architecture, a parallel computing architecture, or a combination thereof. In addition, the server computing system 130 may include a plurality of computing devices connected via the network 170.

In addition, the server computing system 130 may store the at least one machine learning model 140. For example, the server computing system 130 may include a neural network and/or another multi-layer nonlinear model as the machine learning model 140. Examples of the neural network may include a feed-forward neural network, a deep neural network, a recurrent neural network, and a convolutional neural network, without being limited thereto.

In an embodiment, the server computing system 130 may further include a data store computing system (hereinafter, “data store”), which may be a repository for continuously storing and managing raw data that serves as a basis of the tabular data analyzing model training service.

This data store may include various types of data repositories, including a file system and a cloud storage. For example, the data store may include at least one database among a relational database that uses a structured query language (SQL) to define and manipulate data, a NoSQL database that is designed for flexibility and scalability and processes unstructured and semi-structured data, a data warehouse that is a system used for report and data analysis and is optimized for querying and analysis by centralizing big data from several sources, a data warehouse that stores large amounts of raw data as structured data that is a basic format, semi-structured data, and unstructured data, and a local storage device or network attached storage (NAS) that stores data in files in a format that can be generally accessed by a computer operating system.

### Training Computing System 150

The training computing system 150 may include at least one processor 151 and a memory 152. The processor 151 may be configured of at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions, or a plurality of electrically connected processors.

For example, ASICs may have a neuromorphic circuit architecture in the form of an array containing multiple neuron circuits as shown in FIG. 2.

The memory 152 may include one or more non-transitory/transitory computer-readable storage media such as a RAM, a ROM, an EEPROM, an EPROM, a flash memory device, and a magnetic disk, and a combination thereof. The memory 152 may store data 153 and instructions 154 necessary for the processor 151 to perform, for example, training of an artificial intelligence model.

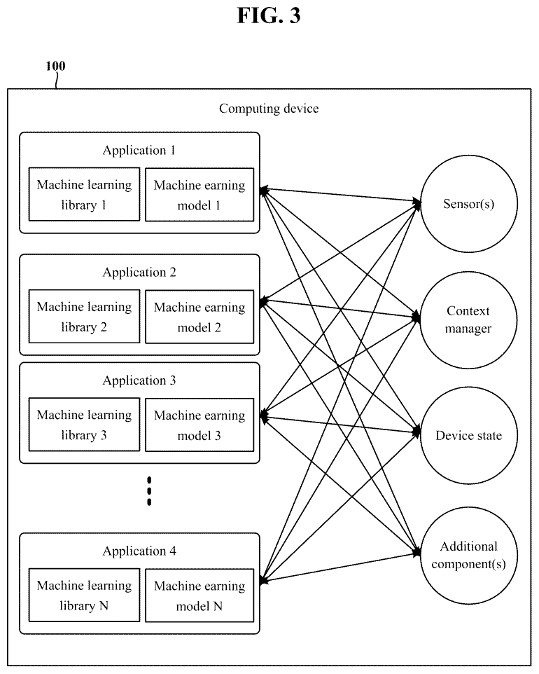

For example, the training computing system 150 may include a model trainer 160 that trains the machine learning model 120 and/or 140 stored on the user computing device 110 and/or the server computing system 130 using various training or learning techniques, such as backpropagation of an error (according to a framework illustrated in FIG. 3).

For example, the model trainer 160 may perform updates on one or more parameters of the machine learning model 120 and/or 140 for the tabular data analyzing model training service in a backpropagation manner based on a defined loss function.

In some implementations, performing the backpropagation of the error may include performing truncated backpropagation through time. The model trainer 160 may perform a large number of generalization techniques (for example, weight reduction, dropout, and/or knowledge distillation) to improve generalization ability of the trained machine learning model 120 and/or 140.

For example, the model trainer 160 may train the machine learning model 120 and/or 140 based on a set of training data 161. The training data 161 may include, for example, data in different formats such as images, audio samples, and/or text. Additionally, the training data 161 may include, for example, the tabular data. Examples of image types that may be used may include video frames, LiDAR point clouds, X-ray images, computed tomography scans, hyperspectral images, and/or various other forms of images, without being limited thereto.

The training data 161 may be provided by the user computing device 110 and/or the server computing system 130. When the training computing device trains the machine learning model 120 and/or 140 for specific data of the user computing device 110, the machine learning model 120 and/or 140 may be characterized as a personalized model.

The model trainer 160 includes a computer logic that is utilized to provide a desired function.

In addition, the model trainer 160 may be implemented as hardware, firmware, and/or software that controls a general-purpose processor. In one implementation, the model trainer 160 may include a program file stored in a storage device, and may be loaded into the memory 152 and executed by the one or more processors 151. In another implementation, the model trainer 160 includes one or more sets of computer-executable data 153 and instructions 154 stored in a tangible computer-readable storage medium, such as a RAM, a hard disk, or an optical or magnetic medium.

The network 170 may include a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (Wireless LAN), a Wide Area Network (WAN), a Personal Area Network (PAN), a Bluetooth network, a satellite broadcasting network, an analog broadcasting network, and/or a Digital Multimedia Broadcasting (DMB) network, or the like, but is not limited thereto.

In general, communication via the network 170 may be performed via various communication protocols (for example, TCP/IP, HTTP, SMTP, and/or FTP), encoding or formats (for example, HTML and/or XML), and/or a protection schema (for example, VPN, Secure HTTP and/or SSL) using any type of wired and/or wireless connection.

FIG. 3 is a block diagram of a computing device for learning tabular data analyzing model according to an embodiment of the invention.

For example, the computing device 100 shown in FIG. 3 may be included in at least one of the user computing device 110, the server computing system 130, and the training computing system 150 which may constitute the computing system 1000 of FIG. 1.

Referring to FIG. 3, a computing device 100 may include a large number of applications (for example, application 1 to application N). Each application may include a machine learning library and one or more machine learning models. Examples of the application may include an image processing (for example, Detection, Classification, and/or Segmentation) application, a text messaging application, an email application, a dictation application, a virtual keyboard application, a browser application, and/or a chat-bot application, without being limited thereto.

In an embodiment, the computing device 100 may include the model trainer 160 for training an artificial intelligence model, and may store and operate the trained artificial intelligence model to provide output data according to certain input data (for example, tabular data).

Each application of the computing device 100 may perform communication with, for example, a large number of other components of the computing device 100, such as at least one sensor, a context manager, a device state component, and/or additional components. In an embodiment, each application may perform communication with each device component using an API (for example, a public API). In an embodiment, the API used by each application may be specific to the application.

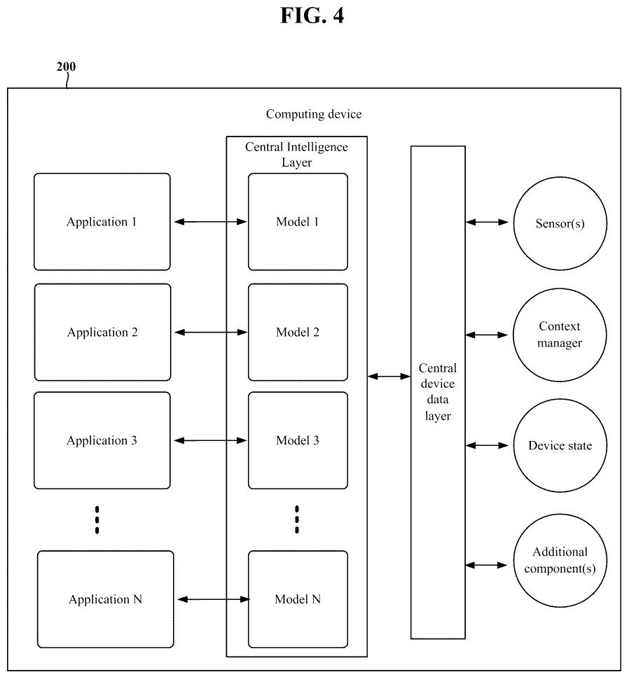

FIG. 4 is a block diagram of a computing device for learning tabular data analyzing model according to another embodiment of the invention.

Referring to FIG. 4, the computing device 200 may include a large number of applications (for example, application 1 to application N). Each application may perform communication with a central intelligence layer. Examples of the applications may include an image processing application, a text messaging application, an email application, a dictation application, a virtual keyboard application, and/or a browser application. In an embodiment, each application may perform communication with the central intelligence layer (and a model stored therein) using an API (for example, a common API across all the applications).

The central intelligence layer may include a large number of machine learning models. For example, as illustrated in FIG. 4, at least some of the machine learning models may be provided to the respective applications and managed by the central intelligence layer. In another implementation, two or more applications may share a single machine learning model. For example, in some implementations, the central intelligence layer may provide a single model to all the applications. In other implementations, the central intelligence layer may be included within an operating system of the computing device 200 or implemented in a different manner.

The central intelligence layer may perform communication with a central device data layer. The central device data layer may be a centralized data repository for the computing device 200. As illustrated in FIG. 4, the central device data layer may perform communication with, for example, a large number of other components of the computing device 200, such as one or more sensors, a context manager, a device state component, and/or additional components. In some implementations, the central device data layer may perform communication with each device component using an API (for example, a private API).

The embodiments described herein may reference servers, databases, software applications, and other computer-based systems, as well as actions taken and information transmitted to or from the system. It is contemplated that intrinsic flexibility of the computer-based systems allows for a wide range of possible configurations, combinations, and divisions of tasks, and functionality between and from components. For example, the processes described herein may be implemented using a single device or component, or a large number of devices or components operating in combination. The databases and applications may be implemented in a single system or in a distributed system across a large number of systems. Distributed components may operate sequentially or in parallel.

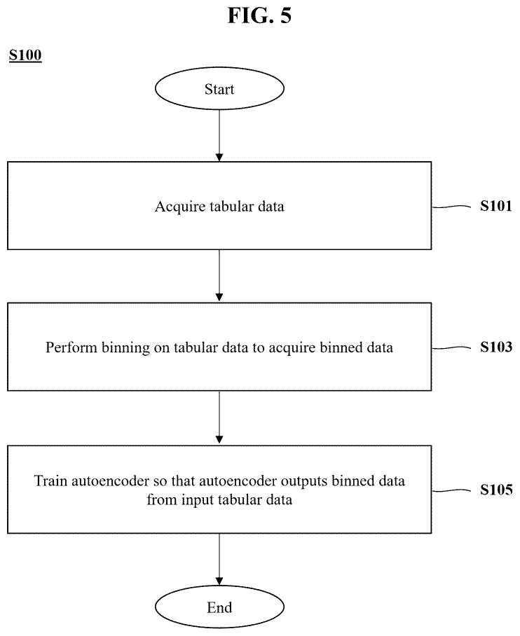

### Tabular Data Analyzing Model Training Method (S100 of FIG. 5)

Hereinafter, a tabular data analyzing model training method in which binning for assigning bin values to various data values included in the tabular data set according to a predetermined criterion is performed, and the autoencoder is trained by utilizing binned data acquired by performing the binning on the tabular data set in order to efficiently learn the tabular data set will be described in detail with reference to the accompanying drawings including FIGS. 5 through 12.

The tabular data set may be structured, for example, in a table format including row information representing a plurality of various heterogeneous features of individual samples and column information representing information on one feature of a plurality of samples.

The tabular data set can have both categorical features that are difficult to represent in numbers and can be represented as, for example, a combination of characters, nouns, and specific words, such as gender and country, and numerical features that can be represented in numbers, such as height, weight, and age, such that the tabular data set can have heterogeneous features.

In order for the artificial intelligence model to efficiently learn the features of the tabular data set, it is necessary to sufficiently handle such heterogeneous features of the tabular data set.

To this end, a tabular data analyzing model training method (S100) according to an embodiment performs binning on the tabular data to generate binned data, and trains the autoencoder based on the tabular data and the binned data, thereby constructing an artificial intelligence model that can effectively extract features that appropriately reflect the heterogeneous features of the tabular data.

Herein, the binned data may refer to a specific numerical value assigned to data included in the tabular data. For example, the binned data may be data corresponding to a representative value assigned to numerical data corresponding to a predetermined range or a specific numerical value assigned to categorical data, and may be data corresponding to a bin value.

Thus, the binned data generated by performing the binning on the tabular data may be data obtained by applying an inductive bias to the tabular data.

For example, according to the tabular data analyzing model training method (S100), the tabular data can be input to the autoencoder, and the autoencoder can be trained to output the binned data generated by performing the binning on the tabular data, and the autoencoder trained in this way can effectively extract features including irregularities of the tabular data.

According to the tabular data analyzing model training method (S100), since data samples with similar values can be grouped by performing the binning on the tabular data, data features that are robust to a minor error that may occur due to analysis of ungrouped individual data can be extracted.

Hereinafter, a tabular data analyzing model training method by which the computing system 1000 according to an embodiment can effectively extract a feature of the tabular data based on binning for the tabular data set will be described in detail.

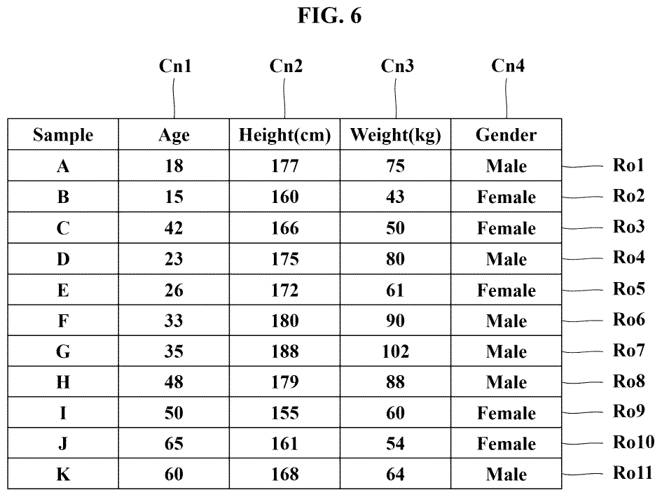

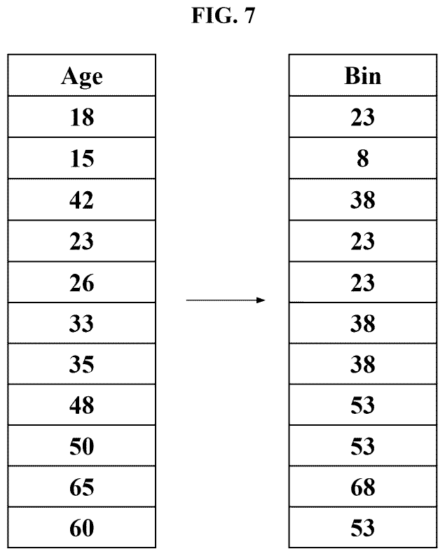

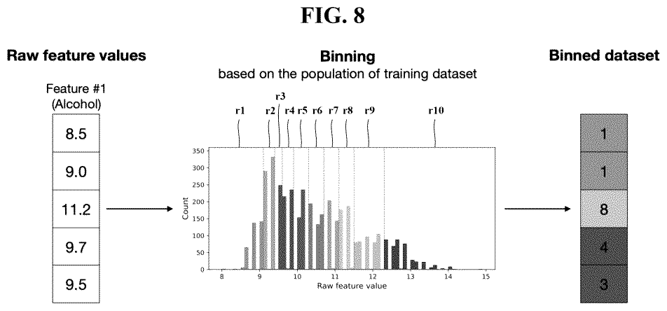

FIG. 5 is a flowchart illustrating a training process for the tabular data according to an embodiment of the invention, FIG. 6 is a tabular data set illustrating a structure of tabular data according to an embodiment of the invention, and FIGS. 7 and 8 illustrate a binning process for tabular data according to an embodiment of the invention.

Referring to FIG. 5, the tabular data analyzing model training method (S100) according to an embodiment may include a step (S101) of acquiring tabular data, a step (S103) of performing binning on the tabular data to acquire binned data, and a step (S105) of training the autoencoder so that the autoencoder outputs binned data from the input tabular data.

For example, the computing system 1000 according to an embodiment may acquire the tabular data (S101).

For example, referring to FIG. 5, the tabular data is related to personal information such as age, height, weight, and gender of several people, and may include information in which various pieces of feature information for the plurality of samples A to K are structured in a table format. Here, the plurality of samples A to K may correspond to the people.

However, the inventive concepts are not limited thereto, and in some embodiments, the tabular data may include various types of information related to various industrial fields. In this case, the tabular data may include numerical information that can be represented as continuous numerical values, and categorical information that is difficult to represent as numerical values and can be represented as a combination of characters, nouns, or specific words.

For example, the tabular data may include numerical information such as year of manufacture, weight, and length of products, and categorical information such as brand names and colors of the product, as information related to the products held by a shop.

In addition, for example, the tabular data may include numerical information such as height, width, and depth of produced goods, and categorical information such as manufacturing process line information and manufacturing process management supervisor information, as information related to goods produced at a manufacturing plant.

Thus, the tabular data may include at least one of the numerical information and the categorical information, and may be data of information in which various types of information on the plurality of samples are structured in a table format. In addition, the tabular data may include information on various types of samples related to various industrial fields.

Such tabular data may show heterogeneous features by including both the numerical information and the categorical information. In addition, since information on a plurality of samples included in the tabular data may have irregular values regardless of a specific pattern, the tabular data may have irregularities.

Therefore, in order for the artificial intelligence model to perform various tasks based on the tabular data, it is necessary to sufficiently consider the heterogeneous features of the tabular data and, at the same time, effectively learn the irregularities of the tabular data.

The computing system 1000 according to an embodiment may receive and acquire the tabular data from the outside. In this case, the computing system 1000 may directly receive the tabular data from the outside, or may extract the tabular data from data of a document (for example, a paper, a book, a patent document, or a report) input from the outside.

For example, the computing system 1000 may extract the tabular data structured in a table format from input document data based on a document understanding model included in the machine learning model 120 and/or 140.

In addition, the computing system 1000 according to an embodiment may perform binning on the tabular data to acquire binned data (S103).

Here, the binning may refer to designating one representative value for information included in a predetermined numerical range among various pieces of information included in the tabular data. The representative value may be referred to as a bin value.

The binned data may be data regarding a plurality of bin values generated by performing the binning on the tabular data.

For example, the tabular data may include a plurality of pieces of column information, and at least one of the plurality of pieces of column information may include numerical data for a feature of each of a plurality of samples.

For example, referring to FIG. 6, tabular data including information on several people may include first column information regarding age, second column information regarding height, third column information regarding weight, and fourth column information regarding gender.

Among the first to fourth column information, some column (for example, a first column Cn1, a second column Cn2, and a third column Cn3) information may include numerical data for features of each of a plurality of samples A to K. For example, as illustrated in FIGS. 6 and 7, the first column information regarding the age may include numerical information regarding the age of each of the plurality of samples A to K.

The bin values, which are representative values to be assigned to various pieces of information included in the tabular data, may be set according to a predetermined criterion, but the embodiment of the invention is not limited thereto and the bin values may be set irregularly.

For example, referring to FIGS. 6 and 7, the computing system 1000 according to an embodiment may assign the bin value to each of a plurality of pieces of age information of the plurality of samples A to K. In this case, for example, a bin value of 8 may be assigned to the age ranging from 1 to 15, 23 to the age ranging from 16 to 30, 38 to the age ranging from 31 to 45, 53 to the age ranging from 46 to 60, and 68 to the age ranging from 61 to 76.

Meanwhile, among the first to fourth column information, some other column (for example, the fourth column Cn4) information may include categorical data for the feature of each of the plurality of samples A to K. For example, as illustrated in FIG. 6, the fourth column information regarding the gender may include categorical information for the gender of each of the plurality of samples A to K.

In this case, different bin values may be assigned to a plurality of different pieces of categorical data for the plurality of samples A to K included in the tabular data.

For example, a bin value of 1 may be assigned to ‘Male’ included in the fourth column (Cn4) information of FIG. 6, and a bin value of 2 may be assigned to ‘Female’. Thus, the plurality of bin values are assigned to the plurality of different pieces of categorical data included in the tabular data so that the plurality of pieces of categorical data can be converted into numerical data.

Thus, the tabular data includes the plurality of pieces of column information, which are raw feature values related to the features of the plurality of samples, and the raw feature values of the tabular data can be converted into a binned data set.

For example, referring to FIG. 8, the raw feature values in the form of column information included in the tabular data can be converted into the binned data set.

In this case, the raw feature values may be included in a plurality of randomly divided sections, and a bin value, which is a representative value corresponding to the corresponding section, may be assigned to each of the raw feature values.

For example, a first bin value may be assigned to first numerical data belonging to a first range, and a second bin value different from the first bin value may be assigned to second numerical data belonging to a second range different from the first range.

For example, referring to FIG. 8, each of the raw feature values may be included in any one of first to tenth sections r1 to r10, a bin value of 1 may be assigned to the raw feature value belonging to the first section r1, 2 to the raw feature value belonging to the second section r2, 3 to the raw feature value belonging to the third section r3, 4 to the raw feature value belonging to the fourth section r4, 5 to the raw feature value belonging to the fifth section r5, 6 to the raw feature value belonging to the sixth section r6, 7 to the raw feature value belonging to the seventh section r7, 8 to the raw feature value belonging to the eighth section r8, 9 to the raw feature value belonging to the ninth section r9, and 10 to the raw feature value belonging to the tenth section r10.

In this case, a size of the first range to which the first numerical data belongs and a size of the second range to which the second numerical data belongs may be different from each other. For example, as illustrated in FIG. 8, sizes of the first to tenth sections r1 to r10 may be set differently from each other. However, the inventive concepts are not limited thereto, and in some embodiments, the size of the first range to which the first numerical data belongs and the size of the second range to which the second numerical data belongs may be set to be the same.

Meanwhile, the number T of the plurality of bin values assigned to a plurality of pieces of numerical data included in the table data may be set to any value.

For example, the number T of the plurality of bin values may be 2 to 100. However, the embodiment of the invention is not limited thereto and the number T of the plurality of bin values may be set to be less than 2 or more than 100.

For example, the number T of the plurality of bin values may be 5 to 100.

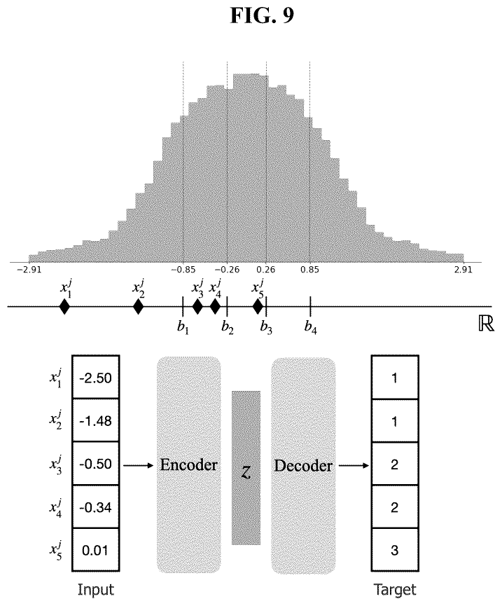

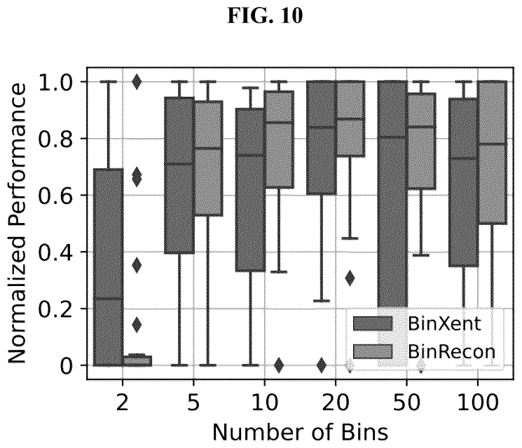

FIG. 9 illustrates a learning process of an autoencoder based on tabular data according to an embodiment of the invention, and FIG. 10 illustrates a correlation between the number of bin values included in binned data generated through binning for tabular data and performance of a model generated as a result of learning according to an embodiment of the invention.

Referring to FIGS. 9 and 10, when the autoencoder trained based on the binned data generated by performing the binning on the tabular data as the number T of the plurality of bin values is set to 5 to 100 is used, an ability to perform the downstream task can be improved. Thus, the same bin value may be assigned to some pieces of numerical data in a

predetermined range among the plurality of pieces of numerical data for the plurality of samples included in the tabular data. In addition, different bin values may be assigned to the plurality of different pieces of categorical data for the plurality of samples included in the tabular data. The plurality of bin values assigned to the plurality of samples can be referred to as binned data.

Accordingly, binned data obtained by replacing the plurality of pieces of numerical data included in the tabular data with bin values that are representative values of the corresponding range, or binned data obtained by replacing the plurality of pieces of categorical data with bin values in numerical value form can be acquired.

Since such binned data is data generated by replacing the numerical data or the categorical data included in existing tabular data with the bin value rather than an original value, the binned data may be data obtained by applying the inductive bias to the tabular data.

In addition, the computing system 1000 according to an embodiment can train the autoencoder so that the autoencoder outputs the binned data from the tabular data (S105).

For example, the computing system 1000 can input the acquired tabular data to the autoencoder included in the machine learning model 120 and/or 140, and train the autoencoder so that the autoencoder outputs the binned data generated according to the binning performed on the tabular data.

For example, referring to FIG. 9, the autoencoder may include an encoder and a decoder. The encoder may generate latent variable data Z based on input tabular data. In this case, the encoder may generate the latent variable data Z obtained by reducing the dimension of a vector for tabular data input Input.

The encoder may include, for example, a fully connected neural network. However, the embodiment of the invention is not limited thereto, and the encoder may include at least one neural network model of any form, such as a convolutional neural network (CNN) or a recurrent neural network (RNN).

The latent variable data Z generated by the encoder may be input to the decoder, and the decoder may be trained to generate target data based on the latent variable data Z. In this case, the target data may be set as the binned data generated through the binning, that is, data of the plurality of bin values. Accordingly, the decoder may be trained to output the binned data based on the latent variable data Z.

For example, referring to FIG. 9, binning may be performed on a plurality of pieces of numerical data included in the tabular data input, and the plurality of bin values, which are binned data, may be set.

For example, a first bin value b1 is assigned to the numerical data belonging to the first section (−2.91≤x<−0.85), a second bin value b2 may be assigned to numerical data belonging to the second section (−0.85≤x<−0.26), a third bin value b3 may be assigned to numerical data belonging to the third section (−0.26≤x<0.26), and a fourth bin value b4 may be assigned to numerical data belonging to the fourth section (0.26≤x<0.85).

The encoder may generate the latent variable data Z corresponding to the tabular data input Input, and the decoder may be trained to output the binned data generated by performing the binning on the tabular data input Input based on the latent variable data Z.

For example, the autoencoder can be trained to output the first bin value b1 for the first numerical data to which the first bin value b1 is assigned, and output the second bin value b2 different from the first bin value b1 for the second numerical data to which the second bin value b2 is assigned.

In this case, the autoencoder can be trained by optimizing the loss function L_{BinRecon} according to Formula (1) below.

$${ℒ}_{BinRecon} := \frac{1}{N} {\sum }_{i = 1}^{N} {‖ {t}_{i} - {f}_{d}^{BinRecon} ( {z}_{i} ) ‖}_{2}^{2} \qquad [ Formula 1 ]$$

(where, tᵢ denotes an i-th bin value, f_{d}^{BinRecon} denotes a decoder output value, and zᵢ denotes an i-th latent variable)

In addition, for example, binning may be performed on a plurality of pieces of categorical data included in the tabular data input, and the plurality of bin values, which are the binned data, may be set.

The computing system 1000 according to an embodiment can generate an embedding vector for the categorical data and train the autoencoder so that the autoencoder outputs the binned data for the categorical data based on the embedding vector for the categorical data.

For example, the autoencoder can be trained to output the first bin value for the first categorical data having the first bin value assigned thereto, and output the second bin value for the second categorical data having the second bin value different from the first bin value assigned thereto.

In this case, the autoencoder can be trained by optimizing a loss function L_{BinXent} according to the following Formula (2).

$${ℒ}_{BinXent} := \qquad [ Formula 2 ]$$

$$- \frac{1}{Nd} {\sum }_{i = 1}^{N} {\sum }_{j = 1}^{d} {u}_{i}^{j} log {f}_{d}^{BinXent} ( {z}_{i}^{j} ) + ( 1 - {u}_{i}^{j} ) log ( 1 - {f}_{d}^{BinXent} ( {z}_{i}^{j} ) )$$

(where, uᵢ^{j} denotes a one-hot vector for tᵢ^{j}, which is an i-th bin value for a j-th feature, f_{d}^{BinRecon} denotes a decoder output value, and zᵢ^{j} denotes an i-th latent variable)

Thus, the autoencoder can be trained to output the binned data from the tabular data by the computing system 1000 according to an embodiment, and accordingly, the finally trained autoencoder can effectively extract the features including irregularities of the tabular data.

In addition, the autoencoder is trained based on the binned data generated by performing the binning on the tabular data. Since the autoencoder is trained based on the data obtained by appropriately applying the inductive bias to the tabular data, an irregular function that can be applied to the autoencoder can be effectively trained in such a process.

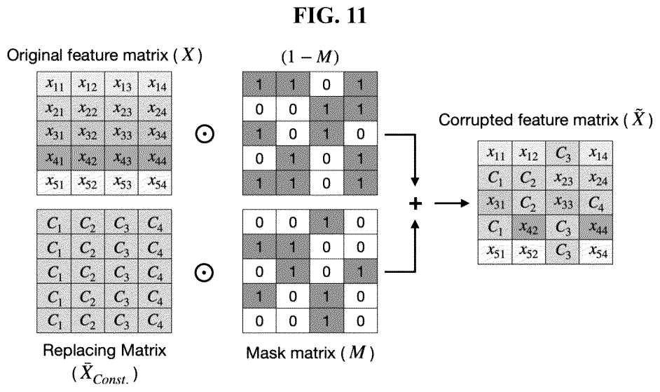

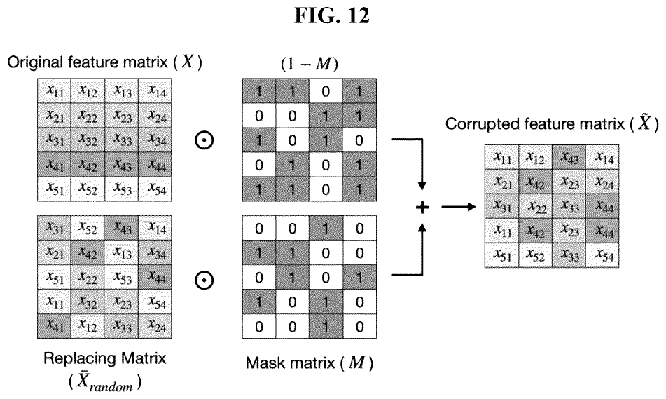

FIGS. 11 and 12 illustrate a preprocessing process for tabular data according to an embodiment of the invention.

Referring to FIGS. 11 and 12, the computing system 1000 according to an embodiment may generate an embedding vector X for the tabular data.

For example, the computing system 1000 according to an embodiment may generate the embedding vector X by performing embedding on the plurality of pieces of numerical data and/or the plurality of pieces of categorical data included in the acquired tabular data. The embedding vector X can have a feature matrix form including information on features included in the tabular data.

In addition, the computing system 1000 according to an embodiment can perform a predetermined operation on the embedding vector X to generate a transformed feature vector \tilde{X} according to [Formula 3] below.

$$\tilde{X} = ( 1 - M ) ⊙ X + M ⊙ \overline{X} \qquad [ Formula 3 ]$$

(wherein, M denotes a masking vector, and X̅ denotes an element replacement vector)

The element replacement vector X̅ may be a constant vector in which all elements are constants (FIG. 11), or may be a vector having elements with the same rear subscript but different front subscript compared to respective elements of the embedding vector X (FIG. 12). Here, the rear subscript of the element replacement vector X̅ may be a number indicating a type of feature included in the tabular data, and the front subscript may be a number indicating an order of samples for the same feature.

Thus, the computing system 1000 according to an embodiment may generate the transformed feature vector \tilde{X} through an element-wise product operation on the embedding vector X, a masking vector M, and the element replacement vector X̅ for the tabular data.

The computing system 1000 according to an embodiment can perform a training process by inputting the transformed feature vector \tilde{X} to the autoencoder described with reference to FIG. 9 when performing a process of training the autoencoder.

When the autoencoder trained based on data obtained by performing masking on the tabular data in this way is used, the ability to perform various downstream tasks can be further improved.

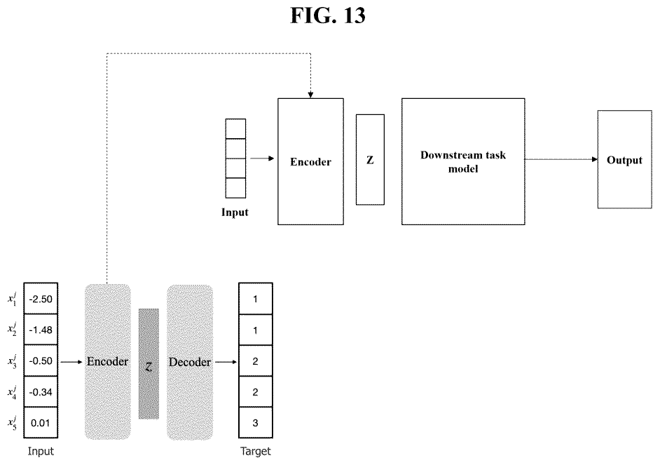

FIG. 13 is a diagram illustrating a structure of an artificial intelligence model obtained by combining an encoder trained based on binned data generated by performing binning on tabular data with a downstream task model according to an embodiment of the invention.

Referring to FIG. 13, the artificial intelligence model in which an encoder included in the autoencoder trained based on the tabular data and binned data for the tabular data and an arbitrary downstream task model are combined may perform various tasks based on the tabular data input.

For example, the encoder trained to generate the latent variable data Z, which reflects the features including the irregularities of the tabular data based on the tabular data and the binned data for the tabular data, may be combined with a downstream task model that can perform classification (for example, binary classification or multiclass classification). This model can effectively perform classification on input data based on the tabular data input.

The downstream task model may be, for example, a model that can perform regression instead of classification. However, the inventive concepts are not limited thereto, and in some embodiments, the downstream task model may include a model capable of performing various tasks other than the classification and the regression.

Thus, when a task for the tabular data is performed by using a model obtained by combining a downstream task model capable of performing various tasks with an encoder trained based on the tabular data and the binned data for the tabular data, it is possible to perform the task while effectively extracting a feature for the tabular data, thereby performing the task for the tabular data more effectively.

According to various embodiments of the invention, it may possible to apply a proper inductive bias to a tabular data set so that an artificial intelligence model can effectively learn an irregular function by performing binning on the tabular data set.

According to various embodiments of the invention, it may also be possible for an auto-encoding-based self-supervised learning (SSL) model to effectively extract features including irregularities of an input tabular data set by training the auto-encoding-based self-supervised learning (SSL) model so that the model outputs binned data acquired by performing binning on the tabular data set from the tabular data set.

According to various embodiments of the invention, it may further be possible to provide an artificial intelligence model capable of effectively performing various types of tasks based on a tabular data set by combining an encoder trained to effectively extract features of the tabular data set with various types of downstream task models.

The embodiment of the invention described above may be implemented in the form of program instructions that can be executed through various computer components and recorded on a computer-readable recording medium. The computer-readable recording medium may include program instructions, data files, data structures, and the like, alone or in combination. The program instructions recorded on the computer-readable recording medium may be those specially designed and configured for the invention or those known and available to those skilled in the art of computer software. Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory. Examples of the program instruction include not only machine language codes such as codes generated by a compiler, but also high-level language codes that can be executed by a computer using an interpreter, or the like. The hardware device may be changed into one or more software modules to perform the processing according to the present disclosure, and vice versa.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for learning tabular data analyzing model in a computing system including a memory and a processor, the method comprising the steps of:
acquiring tabular data;
performing binning on the tabular data to acquire binned data; and
training an autoencoder to output the binned data from the input tabular data.

2. The method of claim 1, wherein:
the tabular data includes a plurality of pieces of column information;
at least one of the plurality of pieces of column information includes numerical data for a feature of each of a plurality of samples; and
the step of performing binning on the tabular data includes a step of assigning the same bin value to some pieces of numerical data in a predetermined range among a plurality of pieces of numerical data for the plurality of samples.

3. The method of claim 1, wherein:
the tabular data includes a plurality of pieces of column information;
at least one of the plurality of pieces of column information includes categorical data for a feature of each of the plurality of samples; and
the step of performing binning on the tabular data includes a step of assigning different bin values to a plurality of different pieces of categorical data for the plurality of samples.

4. The method of claim 2, wherein the step of training the autoencoder includes the steps of:
training the autoencoder to output a first bin value for first numerical data having the first bin value assigned thereto; and
training the autoencoder to output a second bin value different from the first bin value for second numerical data having the second bin value assigned thereto.

5. The method of claim 3, wherein the step of training the autoencoder includes the steps of:
training the autoencoder to output a first bin value for first categorical data having the first bin value assigned thereto; and
training the autoencoder to output a second bin value different from the first bin value for second categorical data having the second bin value assigned thereto.

6. The method of claim 1, further comprising the steps of:
generating an embedding vector X for the tabular data; and
performing a predetermined operation on the embedding vector X according to [Formula] below to generate a transformed feature vector \tilde{X},
wherein the step of performing binning on the tabular data includes a step of performing the binning on the transformed feature vector \tilde{X}.
$$\tilde{X} = ( 1 - M ) ⊙ X + M ⊙ \overline{X} \qquad [ Formula ]$$
(wherein, M denotes a masking vector, and X̅ denotes an element replacement vector)

7. The method of claim 2, wherein the step of training the autoencoder includes a step of training the autoencoder by optimizing a loss function L_{BinRecon} according to [Formula] below.
$${ℒ}_{BinRecon} := \frac{1}{N} {\sum }_{i = 1}^{N} {‖ {t}_{i} - {f}_{d}^{BinRecon} ( {z}_{i} ) ‖}_{2}^{2} \qquad [ Formula ]$$
(where, tᵢ denotes an i-th bin value, f_{d}^{BinRecon} denotes a decoder output value, and zᵢ denotes an i-th latent variable)

8. The method of claim 3, wherein the step of training the autoencoder includes a step of training the autoencoder by optimizing a loss function L_{BinXent} according to [Formula] below.
$${ℒ}_{BinXent} := \qquad [ Formula ]$$
$$- \frac{1}{Nd} {\sum }_{i = 1}^{N} {\sum }_{j = 1}^{d} {u}_{i}^{j} log {f}_{d}^{BinXent} ( {z}_{i}^{j} ) + ( 1 - {u}_{i}^{j} ) log ( 1 - {f}_{d}^{BinXent} ( {z}_{i}^{j} ) )$$
(where, uᵢ^{j} denotes a one-hot vector for tᵢ^{j}, which is an i-th bin value for a j-th feature, f_{d}^{BinRecon} denotes a decoder output value, and zᵢ^{j} denotes an i-th latent variable)

9. The method of claim 1, wherein the autoencoder includes an encoder configured to generate latent variable data based on the tabular data, and a decoder configured to output the binned data based on the latent variable data.

10. The method of claim 2, wherein in the step of performing binning on the tabular data, a size of a first range to which some pieces of numerical data having a first bin value assigned thereto among the plurality of pieces of numerical data belong, and a size of a second range to which other pieces of numerical data having a second bin value different from the first bin value assigned thereto belong are different from each other.

11. The method of claim 2, wherein the number of bin values for the plurality of pieces of column information included in the tabular data is substantially 5 to substantially 100.

12. The method of claim 3, wherein the number of bin values for the plurality of pieces of column information included in the tabular data is substantially 5 to substantially 100.

13. A system for learning tabular data analyzing model, comprising:
at least one memory; and
at least one processor configured to read at least one instruction stored in the memory and train a tabular data analyzing model,
wherein the at least one processor is configured to:
acquire tabular data,
perform binning on the tabular data to acquire binned data, and
train an autoencoder to output the binned data from the input tabular data.

14. The system of claim 13, wherein the tabular data includes a plurality of pieces of column information.

15. The system of claim 14, wherein at least one of the plurality of pieces of column information includes numerical data for a feature of each of a plurality of samples, and
wherein, when performing binning on the tabular data, the at least one processor is further configured to assign the same bin value to some pieces of numerical data in a predetermined range among a plurality of pieces of numerical data for the plurality of samples.

16. The system of claim 14, wherein at least one of the plurality of pieces of column information includes categorical data for a feature of each of the plurality of samples, and
wherein, when performing binning on the tabular data, the at least one processor is further configured to assign different bin values to a plurality of different pieces of categorical data for the plurality of samples.

17. A computing device comprising:
at least one encoder;
at least one decoder;
an autoencoder including the at least one encoder and the at least one decoder; and
at least one processor configured to control the encoder and the decoder,
wherein the at least one processor is configured to:
acquire tabular data,
perform binning on the tabular data to acquire binned data, and
train the autoencoder to output the binned data from the input tabular data.

18. The computing device of claim 17, wherein the tabular data includes a plurality of pieces of column information.

19. The computing device of claim 18, wherein at least one of the plurality of pieces of column information includes numerical data for a feature of each of a plurality of samples, and
wherein, when performing binning on the tabular data, the at least one processor is further configured to assign the same bin value to some pieces of numerical data in a predetermined range among a plurality of pieces of numerical data for the plurality of samples.

20. The computing device of claim 18, wherein at least one of the plurality of pieces of column information includes categorical data for a feature of each of the plurality of samples, and
wherein, when performing binning on the tabular data, the at least one processor is further configured to assign different bin values to a plurality of different pieces of categorical data for the plurality of samples.
